(19) United States
(12) Patent Application Publication
(10) Pub. No.: US 2025/0124671 A1
(43) Pub. Date: Apr. 17, 2025

(54) UBIQUITOUS TANGIBLE OBJECT UTILIZATION THROUGH CONSISTENT HAND-OBJECT INTERACTION IN AUGMENTED REALITY

(71) Applicant: Purdue Research Foundation, West Lafayette, IN (US)

(72) Inventors: Karthik Ramani, West Lafayette, IN (US); Jingyu Shi, West Lafayette, IN (US); Rahul Jain, West Lafayette, IN (US)

(21) Appl. No.: 18/908,885

(22) Filed: Oct. 8, 2024

Related U.S. Application Data
(60) Provisional application No. 63/543,930, filed on Oct. 13, 2023.

(51) Int. Cl. G06T 19/00; G06V 10/74; G06V 10/764; G06V 40/10; G06V 40/20

(52) U.S. Cl. CPC G06T 19/006; G06V 10/761; G06V 10/764; G06V 40/11; G06V 40/28; G06V 2201/07

(57) ABSTRACT

The disclosed system and method enable hand-object interaction with a virtual object in augmented reality or virtual reality. The system and method advantageously suggest particular physical objects in the environment to be used as physical proxies for virtual objects to be interacted with. The system and method maintain physical and mental consistency in the user experience by recommending physical proxies in a manner that takes into consideration the interaction constraints. Finally, the system and method advantageously incorporate a mapping process that takes into consideration the object, the hand gesture, and the contact points on both the physical and virtual object, thereby providing consistent visualization of the virtual hand-object interactions to the users.

This application claims the benefit of priority of U.S. provisional application Ser. No. 62/543,930, filed on Oct. 13, 3023 the disclosure of which is herein incorporated by reference in its entirety.

### GOVERNMENT LICENSE RIGHTS

This invention was made with government support under DUE1839971 awarded by the National Science Foundation. The government has certain rights in the invention.

### FIELD

The devices and methods disclosed in this document relate to augmented reality and, more particularly, to utilizing everyday objects as tangible proxies for haptic feedback while interacting with virtual objects in augmented reality.

### BACKGROUND

Unless otherwise indicated herein, the materials described in this section are not admitted to be the prior art by inclusion in this section.

In Augmented Reality (AR), interacting with virtual components lacks haptic feedback. To address this issue, several approaches have been studied to enable tangible AR applications, such as designing wearable hardware, retargeting to self-haptics, and programming tangible input devices. Recent research on retargeting everyday objects as tangible proxies shows promising results in natural, intuitive, and inclusive interactions with virtual components. By opportunistically repurposing and leveraging existing physical objects in the users' environment as input devices, users are freed from hardware constraints and obtain realistic haptic feedback within the AR experience.

Precise mappings are crucial to the correspondence between everyday physical objects and their intended virtual counterparts to produce interactions that are both physically and mentally aligned for users. Such mappings must satisfy both the geometric and semantic constraints of the components. For example, a cell phone would not be preferred as a proxy for a basketball since they neither share the same geometric attributes nor are used for similar purposes. Thus, formulating reliable mapping criteria is a significant challenge in the investigation of opportunistic tangible proxies.

Prior research has put considerable effort into addressing this challenge. Annexing Reality enables users to define a preference in geometric shape and matches the given virtual object with physical objects in the vicinity that are most similar in the preferred geometric shape. Inspired by this work, follow-up research seeks opportunistic proxy objects by matching the physical attributes of the objects in the interaction. While successfully providing the best-available haptic sensation for virtual objects, such methods put heavy constraints on the physical attributes of the objects and thus restrict the possible range of opportunistic proxies. For instance, a proxy for a virtual basketball would always be a sphere regardless of the affordance of the basketball. It should be appreciated that, without such constraints, the inconsistency in the shapes of the objects may result in Breaks in Presence (BIP) in the user experience and, consequently, defects in the efficiency of the interaction. BIP happens when the proxies have different geometry than the virtual counterparts, resulting in the users interacting with the objects while seeing their physical hands inconsistently penetrating, isolated from, or blocked by the virtual overlays.

What is needed is a system for utilizing everyday objects as tangible proxies for haptic feedback while interacting with virtual objects in AR, which addresses the dilemma between the restrictive physical constraints on object selection and the inconsistency of the user experience, thereby allowing flexible and general-purpose AR prototypes.

### SUMMARY

A method for enabling hand-object interactions with a virtual object in augmented reality or virtual reality is disclosed. The method comprises receiving, with a processor, a selection from a user of a first virtual object with which at least one first interaction is defined. The method further comprises determining, with the processor, a first physical object in the environment to act as a physical proxy for the first virtual object during the at least one first interaction. The method further comprises tracking, with the processor, hand poses of a hand of the user and object poses of the first physical object within the environment over time. The method further comprises displaying, in an augmented reality or virtual reality graphical user interface on a display screen, a graphical representation of the at least one first interaction with the first virtual object based on the hand poses and the object poses, the graphical representation of the at least one first interaction mirroring a physical interaction between the hand of the user and the first physical object.

A non-transitory computer-readable storage medium that stores program instructions for enabling hand-object interactions with a virtual object in augmented reality or virtual reality is disclosed. The program instructions are configured to, when executed by computing device, cause the computing device to receive a selection from a user of a first virtual object with which at least one first interaction is defined. The program instructions are further configured to, when executed by computing device, cause the computing device to determine a first physical object in the environment to act as a physical proxy for the first virtual object during the at least one first interaction. The program instructions are further configured to, when executed by computing device, cause the computing device to track hand poses of a hand of the user and object poses of the first physical object within the environment over time. The program instructions are further configured to, when executed by computing device, cause the computing device to operate a display to display, in an augmented reality or virtual reality graphical user interface, a graphical representation of the at least one first interaction with the first virtual object based on the hand poses and the object poses, the graphical representation of the at least one first interaction mirroring a physical interaction between the hand of the user and the first physical object.

### BRIEF DESCRIPTION OF THE DRAWINGS

The foregoing aspects and other features of the systems and methods are explained in the following description, taken in connection with the accompanying drawings.

FIGS. 1A-1E summarize a workflow for using the virtual object interaction system to interact with a virtual object.

FIG. 2A shows two different grasping interactions with a fork.

FIG. 2B shows a taxonomy that classifies hand-object interactions along two dimensions.

FIG. 3 shows exemplary components of an AR system of an exemplary virtual object interaction system.

FIG. 4 shows a logical flow diagram for a method for enabling hand-object interaction with a virtual object in augmented reality or virtual reality.

FIG. 5 shows some example hand-object interactions for different types of objects in the hand-object interaction database.

FIG. 6 shows an exemplary hardware setup for collecting data for the hand-object interaction database.

FIG. 7 shows exemplary user interface elements that are provided within the AR graphical user interface of the virtual object interaction system.

FIG. 8 shows pseudocode for an algorithm used to determine the suitability of the respective registered object to act as the physical proxy.

FIG. 9 shows a visualization of transferring contact heatmaps from one object to another.

FIG. 10 shows pseudocode for an algorithm for tracking physical hand and object poses and mapping them to a virtual hand-object interaction.

FIG. 11 shows an exemplary hand and object pose optimization process.

FIG. 12 shows an exemplary use case involving table tennis practicing.

FIG. 13 shows a demonstration of how interaction mapping increases the possibility of tangible proxies.

FIG. 14 shows an exemplary use case involving a one-on-one remote tutoring scenario.

FIG. 15 shows an exemplary use case involving a tangible user interface for a smart home.

FIG. 16 shows an exemplary use case involving an AR shooting game.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

### Overview

A virtual object interaction system is introduced herein, which enables hand-object interactions with virtual objects in an augmented reality (AR) environment. The virtual object interaction system advantageously enables flexible utilization of physical objects in the user's environment as haptic proxies for the virtual object, while addressing the dilemma between the constraints on object selection and the inconsistency of the user experience.

Given a virtual object to be interacted with in AR, the virtual object interaction system recommends the best-available proxies in the user's vicinity. Instead of merely focusing on the object attributes such as shape and size when recommending a physical proxy, the virtual object interaction system advantageously considers intended interactions or affordances as one of the criteria while matching between the selected virtual object and potential physical proxies. Particularly, when matching between the selected virtual object and potential physical proxies, the affordances of the potential physical proxies are compared with the intended interactions or affordances of the selected virtual object. The intended interactions may be a subset of all possible interactions/affordances of the virtual object.

Once a physical proxy is selected, the virtual object interaction system maps the real-world hand-object interactions to the virtual hand-object interactions, and provides consistent visualization of the interaction to the users. Particularly, the virtual object interaction system simultaneously tracks and maps user's physical hand-object interactions to virtual hand-object interactions, while adaptively optimizing the object's six degrees-of-freedom (6-DoF) and the hand gesture to provide consistency between the interactions. Thus, the virtual object interaction system keeps the physical and mental consistency in the user experience by recommending for physical proxies taking into consideration the interaction constraints.

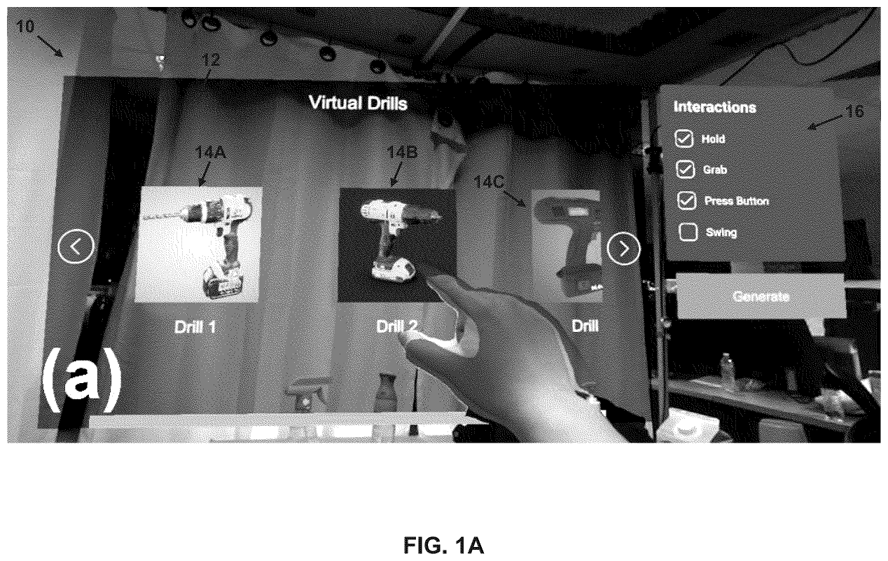

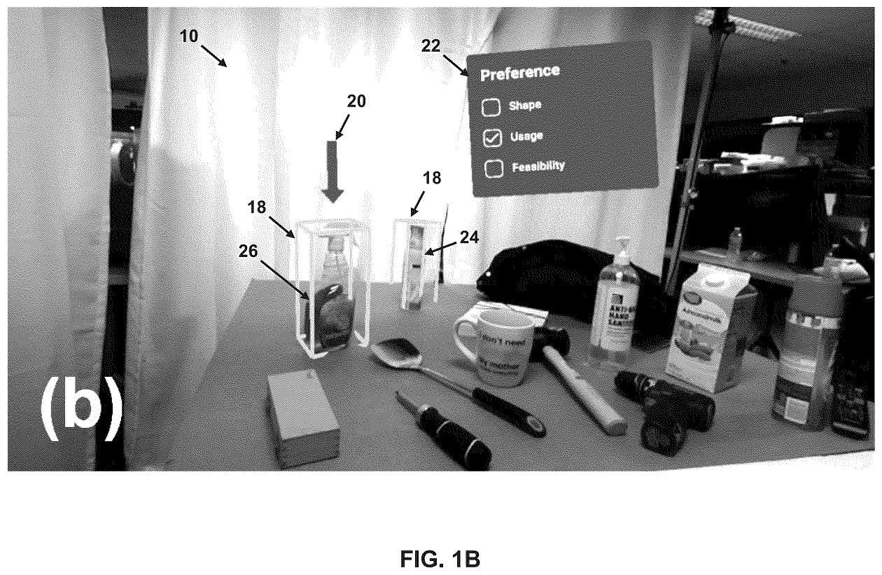

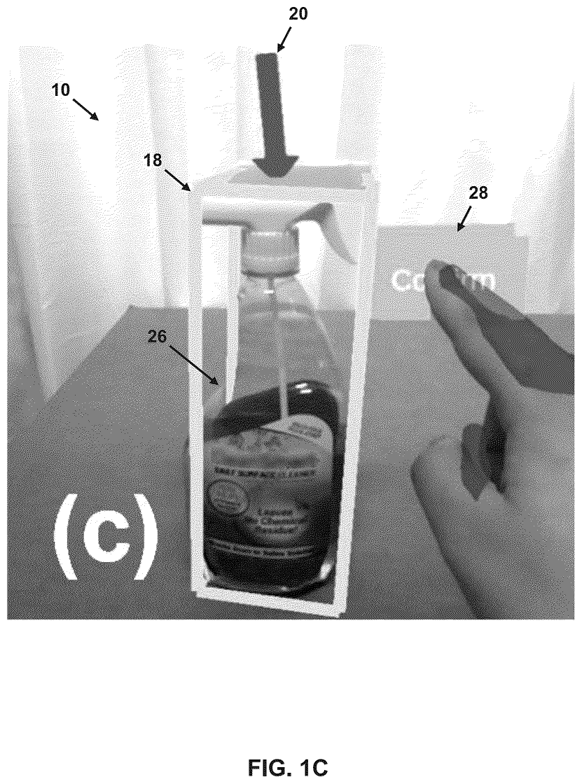

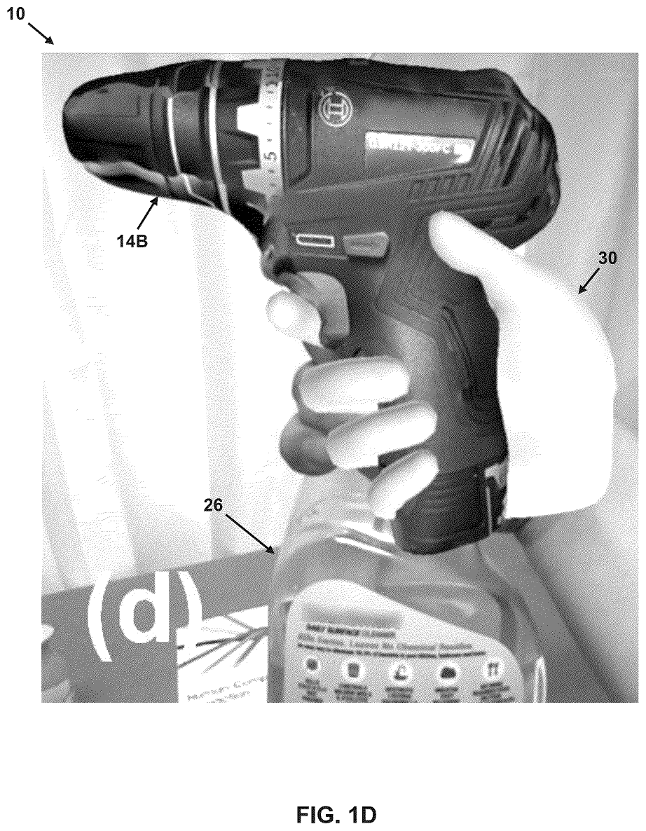

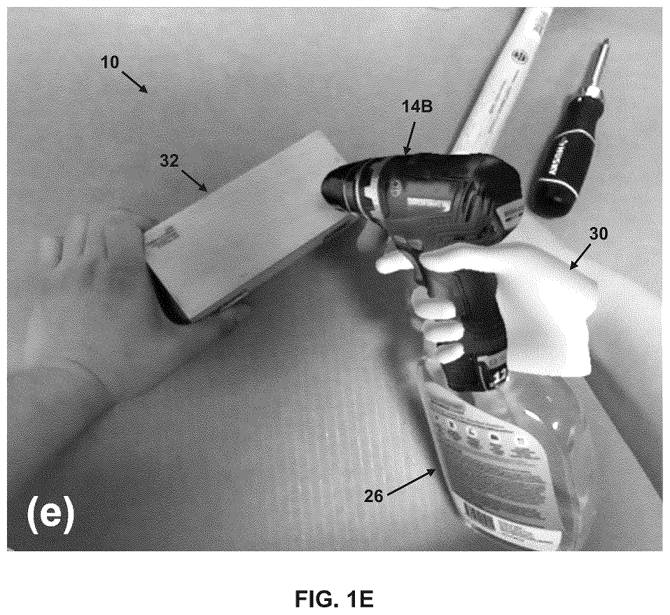

FIGS. 1A-1E summarize a workflow for using the virtual object interaction system to interact with a virtual object. The workflow is described with respect to an example in which a user wants to learn how to use a drill and to practice performing drilling actions. However, there is no drill handy in the user's vicinity. Instead, the user uses the virtual object interaction system.

As shown in FIG. 1A, the virtual object interaction system provides an AR graphical user interface 10 having a virtual object menu 12 via which the user can select a virtual object 14A-C that he or she would like to interact with. The virtual object interaction system provides a database including a wide variety of virtual objects 14A-C that can be interacted with by the user. Once the user selects a virtual object 14B, in particular a virtual drill 14B, (e.g., “Drill 2”) from the database, the augmented reality graphical user interface 10 provides an interaction menu 16 via which the user can select or unselect hand-object interactions that he or she would like to perform with respect to the selected virtual drill 14B.

Next, as shown in FIG. 1B, the virtual object interaction system scans the environment and recommends physical objects within the environment as possible physical proxies for the selected virtual object. Physical objects within the environment that are potentially suitable physical proxies for the selected virtual object are highlighted in the AR graphical user interface 10 with bounding boxes 18, and a recommended choice is indicated with an arrow 20. The AR graphical user interface 10 provides a preference menu 22 via which the user can select a preference that influences how the virtual object interaction system identifies the best recommendation amongst several physical objects that might be suitable physical proxies for the selected virtual object. In the illustrated example, the virtual object interaction system identifies an aerosol spray can 24 and a spray bottle 26 as potential physical proxies for the selected virtual drill, and recommends the spray bottle as the more suitable option. As shown in FIG. 1C, the user selects the spray bottle 26 by interacting with a confirm button 28 in the AR graphical user interface 10.

Once a physical proxy is selected, as shown in FIG. 1D, the virtual object interaction system overlays, in the AR graphical user interface 10, the virtual drill 14B onto the selected physical proxy object and overlays a virtual hand 30 over the user's hand. The pose of the selected physical proxy object (i.e., the spray bottle 26) is mapped onto the virtual drill 14B such that the virtual drill 14B has a same pose as the selected physical proxy object. Likewise, the pose of the user's hand is mapped onto the virtual hand 30 such that the virtual hand 30 has a same pose as the user's hand. Moreover, when the user interacts with the selected physical proxy object with his or her hand in the physical world, the virtual object interaction system maps the physical hand-object interaction onto a virtual hand-object interaction in a realistic and consistent manner. In other words, the interaction between the virtual drill 14B and the virtual hand 30 is displayed with believable contact between the virtual drill 14B and the virtual hand 30, without immersion-breaking intersection or clipping.

Finally, as shown in FIG. 1E, the virtual object interaction system enables the user to realistically interact with the virtual drill 14B with haptic feedback provided by the physical proxy and consistent visualization of the hand-object interaction. As the user interacts with the physical proxy (i.e., the spray bottle 26) and moves the physical proxy throughout the environment, the interactions are accurately and realistically represented in the visualization of the virtual drill 14B. In the illustrated example, the user holds the spray bottle 26 to simulate drilling into a box 32 using the virtual drill 14B.

### Design Rationale

Hand-object interactions are an essential aspect of daily human activity, allowing us to manipulate and interact with objects in our environment. These interactions can involve many actions, such as picking up objects, using tools, and performing deictic gestures. Hand-object interactions have also become increasingly vital in the digital realm, with the development of AR and other immersive technologies. The range of hand-object interactions expands when we blend the virtual and physical worlds.

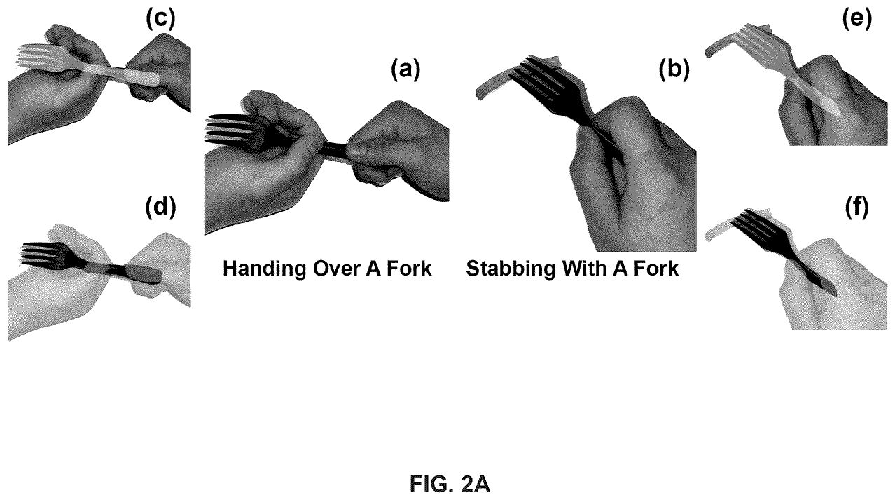

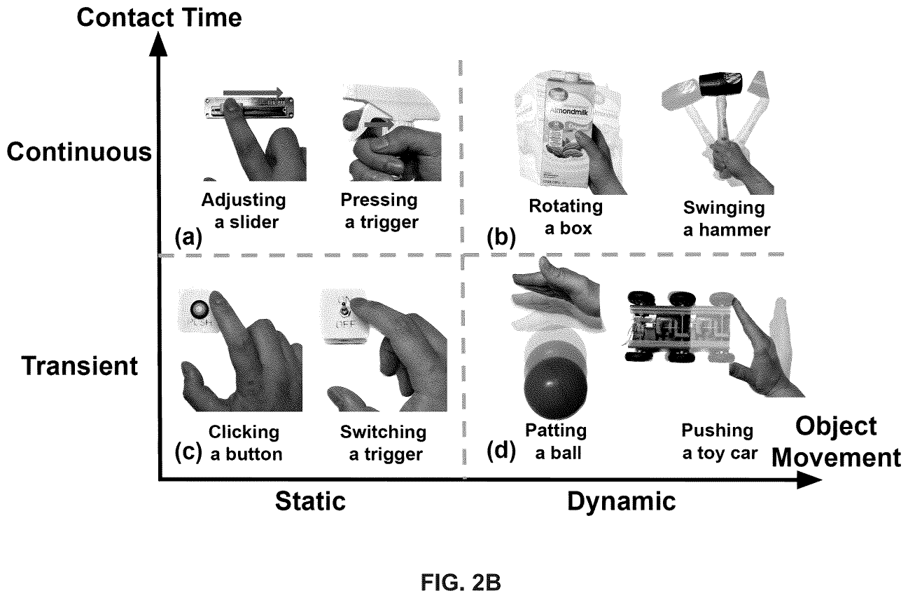

Hand-object interactions are composed of hand gestures, their actions on objects, and the contact points on both the hands and the objects. Consider two different interactions with a fork: (1) using a fork to eat, and (2) handing the fork to another person. As shown in FIG. 2A, people tend to grasp the fork differently in these two different interactions. Particularly, as shown in illustration (a), when handing the fork to another person, people tend to grasp the fork by the fork side, such that the recipient can grasp the fork by the handle and avoid poking themselves. In contrast, as shown in illustration (b), people tend to grasp the fork by the handle to use it to pick up food. Additionally, the grasping gesture, contact points on the hand and the object, as well as the object's 6-DoF, differ between these two interactions. Particularly, as shown in illustrations (c) and (e), the 6-DoF, i.e., the pose, of the fork differs between the two interactions. Likewise, as shown in illustrations (d) and (f), the hand gestures used to grasp the fork and the points of contact between the hand and the fork also slightly differ between the two interactions.

Thus, it should be appreciated that different affordances of the object are typically realized with different hand gestures and different contact points. Conversely, a same affordance applied to a different object will also typically be realized with different hand gestures and different contact points.

FIG. 2B shows a taxonomy that classifies hand-object interactions along two dimensions. The first dimension is the movement of the object during the hand-object interaction. Particularly, a hand-object interaction may be classified as either Static or Dynamic depending on whether there is a change in the 6-DoF, i.e., the pose, of the object during the interaction. For these purposes, both articulate and non-articulate objects are considered as rigid entities. Each object has only one unique center. This center determines whether the interaction is dynamic or static regardless of the hand movement, in order to avoid the complexity induced by the articulation of the object. Static hand-object interactions are those in which the object remains in a fixed position during the hand-object interaction. In other words, the location and orientation of the object remain unchanged during the hand-object interaction. Examples of Static hand-object interactions may include clicking a button, switching a trigger/switch, adjusting a slider on an object, or pressing a trigger on an object. In contrast, Dynamic hand-object interactions are those in which the hand and object are in motion during the hand-object interaction. In other words, the hand manipulates the object in such a way that changes its position or orientation. Examples of Dynamic hand-object interactions may include grasping, lifting, or cutting actions that change the object's 6-DoF, such as rotating a box, swinging a hammer, patting a ball, or pushing a toy car.

The second dimension is the contact time of the hand-object interaction. Particularly, a hand-object interactions may be classified as either Continuous and Transient, based on the length of the contact time. Transient hand-object interactions are those in which the contact between the hand and the object is for a very short period of time. In other words, the contact between the hand and the object is very brief and often contains rapid movements. Examples of Transient hand-object interactions may include clicking a button, switching a trigger/switch, patting a ball, or pushing a toy car. Continuous hand-object interactions are those in which the hand remains in contact with an object for a longer period of time. Examples of Continuous hand-object interactions may include adjusting a slider, pressing a trigger, rotating a box, or swinging a hammer.

The taxonomy introduced above enables hand-object interactions with physical objects acting as proxies to be more effectively mapped to a visual representation of a hand-object interactions with a virtual object. Mapping refers to establishing a correspondence between similar modalities, which can be objects, gestures, and interactions. To use physical objects as proxies for interacting with virtual objects, mappings are needed to keep the consistency between both physical and virtual interactions. The categorization of hand-object interactions according to this taxonomy empowers the mapping between the hand-object interaction by thresholding the search space for mapping. In other words, given a user-selected interaction, we only consider possible interactions of the same category for mapping. For example, a physical Dynamic-Continuous interaction will only be mapped to virtual Dynamic-Continuous interaction.

The mapping process takes into consideration the essential components of a hand-object interaction: the object, the hand gesture, and the contact points on both. With respect to mapping the physical object to the virtual object, the virtual object interaction system considers both object geometry and object affordance as criteria for mapping the physical object to the virtual object.

The virtual object interaction system utilizes geometric features as one of the criteria to map physical objects and virtual objects. Object manipulations are more efficient when physical and virtual objects are alike in shape and size. Geometric attributes of the objects such as shape, curves, size, curvature, and surface normals are used to map virtual objects to physical proxies to provide proximate haptic feedback to the users. The similarity between the geometric features of the objects depicts naturally how similar two objects look and is able to enhance the immersiveness of the AR blending of the virtual object. Therefore, the more geometrically similar the objects are, the more plausible the mapping is.

The virtual object interaction system also utilizes affordance as one of the criteria to map physical objects and virtual objects. As used herein, the term “affordance” refers to both actual and perceived properties or characteristics of an object that suggest how it can be used. In other words, the affordance of an object is what the user can do with it, whether intended or not. For example, in FIG. 2A the fork can be held from the handle while the stabbing action is performed with the points of the fork. While opting for physical proxies for virtual objects, the similarity in object affordance often suggests a more natural substitute due to a similar spectrum of possibilities of actions. The similarity in object affordance is crucial for creating a believable experience. For instance, a saw can be a better proxy for a virtual knife rather than a ruler. Even though a ruler shares similar geometry with a knife, it cannot cover the function of cutting like a knife, especially when the user wants to cut something with a knife. In terms of finding the proxy for a virtual object, the similarity in affordance is more important when the user is to perform an intended interaction with the virtual object. Overall, the concept of affordance is a critical attribute of both virtual and physical objects and is a key characteristic for mappings between physical and virtual hand-object interactions to create a more realistic and immersive experience.

Additionally, when mapping the physical hand-object interaction to the virtual hand-object interaction, hand gestures provide a “hint” for the type of hand-object interactions to be performed. The stabbing interaction of the fork (FIG. 2A) has a wrapping gesture of the hand which indicates the hand is holding something. Often, hand gestures vary with objects and the type of interactions. For instance, the hand gesture of grabbing a bottle is different from that of grabbing a cell phone, even though the interactions are both grabbing. To this end, the virtual object interaction system also utilizes hand gestures as one criterion to map one interaction to another. Intuitively, gestures should be mapped in interactions with similar poses.

Finally, when mapping the physical hand-object interaction to the virtual hand-object interaction, contact points should be taken into consideration. Contact points refer to the points on the objects and hands at which they touch each other during the interactions. For example, contact points on a bottle cap and a base of a bottle signify two different interactions (i.e., opening the bottle and holding the bottle). Contact points on the object indicate the possible interaction performed with the object as well as the gestures. Hence, to map interactions, contact points should also be mapped from one object to another.

### Exemplary Hardware Embodiment

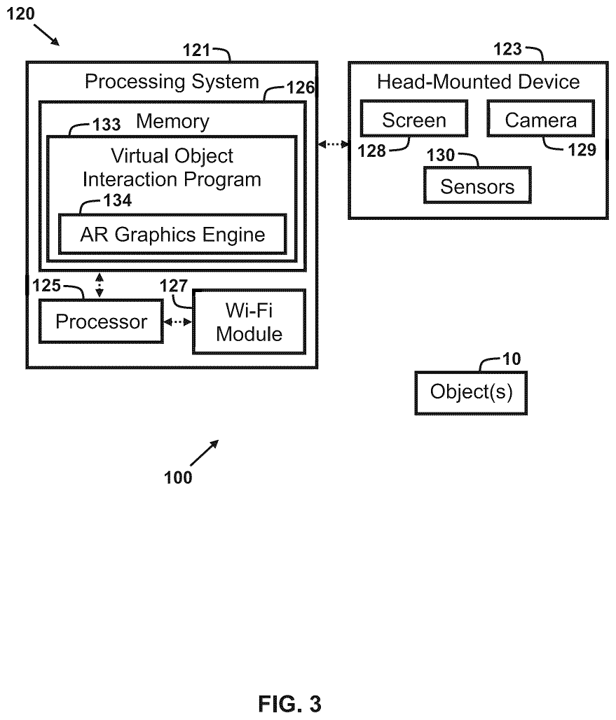

FIG. 3 shows exemplary components of an AR system 120 of an exemplary virtual object interaction system 100. It should be appreciated that the components of the AR system 120 shown and described are merely exemplary and that the AR system 120 may comprise any alternative configuration. Moreover, in the illustration of FIG. 3, only a single AR system 120 is shown. However, in practice the virtual object interaction system 100 may include one or multiple AR systems 120.

To enable hand-object interactions with virtual objects, the virtual object interaction system 100 at least includes the AR system 120, at least part of which is worn or held by a user, and one or more objects 10 in the environment that are scanned or interacted with by the user. The AR system 120 preferably includes the AR-HMD 123 having at least a camera and a display screen, but may include any mobile AR device, such as, but not limited to, a smartphone, a tablet computer, a handheld camera, or the like having a display screen and a camera. In one example, the AR-HMD 123 is in the form of an AR or virtual reality headset (e.g., Microsoft's HoloLens, Oculus Rift, or Oculus Quest) or equivalent AR glasses having an integrated or attached front-facing camera 129. It should be appreciated that, in alternative embodiments, the AR system 120 may equivalently take the form of a VR system. Thus, it should be appreciated that any AR graphical user interfaces described herein may equivalently be provided at least in the form of VR graphical user interfaces.

In the illustrated exemplary embodiment, the AR system 120 includes a processing system 121, the AR-HMD 123, and (optionally) external sensors (not shown). In some embodiments, the processing system 121 may comprise a discrete computer that is configured to communicate with the AR-HMD 123 via one or more wired or wireless connections. In some embodiments, the processing system 121 takes the form of a backpack computer connected to the AR-HMD 123. However, in alternative embodiments, the processing system 121 is integrated with the AR-HMD 123. Moreover, the processing system 121 may incorporate server-side cloud processing systems.

As shown in FIG. 3, the processing system 121 comprises a processor 125 and a memory 126. The memory 126 is configured to store data and program instructions that, when executed by the processor 125, enable the AR system 120 to perform various operations described herein. The memory 126 may be of any type of device capable of storing information accessible by the processor 125, such as a memory card, ROM, RAM, hard drives, discs, flash memory, or any of various other computer-readable media serving as data storage devices, as will be recognized by those of ordinary skill in the art. Additionally, it will be recognized by those of ordinary skill in the art that a “processor” includes any hardware system, hardware mechanism or hardware component that processes data, signals or other information. The processor 125 may include a system with a central processing unit, graphics processing units, multiple processing units, dedicated circuitry for achieving functionality, programmable logic, or other processing systems.

The processing system 121 further comprises one or more transceivers, modems, or other communication devices configured to enable communications with various other devices. Particularly, in the illustrated embodiment, the processing system 121 comprises a Wi-Fi module 127. The Wi-Fi module 127 is configured to enable communication with a Wi-Fi network and/or Wi-Fi router (not shown) and includes at least one transceiver with a corresponding antenna, as well as any processors, memories, oscillators, or other hardware conventionally included in a Wi-Fi module. As discussed in further detail below, the processor 125 is configured to operate the Wi-Fi module 127 to send and receive messages, such as control and data messages, to and from other devices via the Wi-Fi network and/or Wi-Fi router. It will be appreciated, however, that other communication technologies, such as Bluetooth, Z-Wave, Zigbee, or any other radio frequency-based communication technology can be used to enable data communications between devices in the system 100.

In the illustrated exemplary embodiment, the AR-HMD 123 comprises a display screen 128 and the camera 129. The camera 129 is configured to capture a plurality of images of the environment as the AR-HMD 123 is moved through the environment by the user. The camera 129 is configured to generate image frames of the environment, each of which comprises a two-dimensional array of pixels. Each pixel at least has corresponding photometric information (intensity, color, and/or brightness). In some embodiments, the camera 129 operates to generate RGB-D images in which each pixel has corresponding photometric information and geometric information (depth and/or distance) or, alternatively, separate RGB color images and depth images. In such embodiments, the camera 129 may, for example, take the form of an RGB camera that operates in association with a LIDAR camera to provide both photometric information and geometric information. Alternatively, or in addition, the camera 129 may comprise two RGB cameras configured to capture stereoscopic images, from which depth and/or distance information can be derived. In one embodiment, the resolution is 1280×720 for both the RGB color data and the depth data.

In some embodiments, the AR-HMD 123 may further comprise a variety of sensors 130. In some embodiments, the sensors 130 include sensors configured to measure one or more accelerations and/or rotational rates of the AR-HMD 123. In one embodiment, the sensors 130 include one or more accelerometers configured to measure linear accelerations of the AR-HMD 123 along one or more axes (e.g., roll, pitch, and yaw axes) and/or one or more gyroscopes configured to measure rotational rates of the AR-HMD 123 along one or more axes (e.g., roll, pitch, and yaw axes). In some embodiments, the sensors 130 may further include IR cameras. In some embodiments, the sensors 130 may include inside-out motion tracking sensors configured to track human body motion of the user within the environment, in particular positions and movements of the head, arms, and hands of the user.

The display screen 128 may comprise any of various known types of displays, such as LCD or OLED screens. In at least one embodiment, the display screen 128 is a transparent screen, through which a user can view the outside world, on which certain graphical elements are superimposed onto the user's view of the outside world. In the case of a non-transparent display screen 128, the graphical elements may be superimposed on real-time images/video captured by the camera 129.

The AR-HMD 123 may also include a battery or other power source (not shown) configured to power the various components within the AR-HMD 123, which may include the processing system 121, as mentioned above. In one embodiment, the battery of the AR-HMD 123 is a rechargeable battery configured to be charged when the AR-HMD 123 is connected to a battery charger configured for use with the AR-HMD 123.

The program instructions stored on the memory 126 include a virtual object interaction program 133. As discussed in further detail below, the processor 125 is configured to execute the virtual object interaction program 133 to enable hand-object interactions with virtual objects using physical objects as haptic proxies. In one embodiment, the virtual object interaction program 133 is implemented with the support of Microsoft Mixed Reality Toolkit (MRTK). In one embodiment, the virtual object interaction program 133 includes an AR graphics engine 134 (e.g., Unity3D engine), which provides an intuitive visual interface for the virtual object interaction program 133. Particularly, the processor 125 is configured to execute the AR graphics engine 134 to superimpose on the display screen 128 graphical elements for the purpose of enabling hand-object interactions with virtual objects using physical objects as haptic proxies, including suggesting particular physical objects in the environment to be used as the haptic proxies.

Methods for Enabling Hand-object interactions with Virtual Objects

The virtual object interaction system 100 is configured to enable hand-object interactions with virtual objects using physical objects as haptic proxies, including suggesting particular physical objects in the environment to be used as the haptic proxies, using an AR-based graphical user interface on the display 128. To this end, the AR system 120 is configured to provide a variety of AR graphical user interfaces and interactions therewith which can be accessed in the following four modes of the AR system 120: Search Mode, Browse Mode, Scene Mode, and Interaction Mode. In the Search Mode, the AR system 120 enables the user to search through and select available virtual objects that can be interacted with. In the Browse Mode, the AR system 120 enables the user to visualize a selected virtual object and configure the hand-object interactions to be performed with respect to the virtual object. In the Scene Mode, the AR system 120 suggests physical objects in the user's environment that might be used as a haptic proxy for the virtual object during interaction and permits the user to select the best haptic proxy based on their preference. Finally, in Interaction Mode, the AR system 120 enables hand-object interactions with the virtual object.

A variety of methods, workflows, and processes are described below for enabling the operations and interactions of the Search Mode, Browse Mode, Scene Mode, and Interaction Mode of the AR system 120. In these descriptions, statements that a method, workflow, processor, and/or system is performing some task or function refers to a controller or processor (e.g., the processor 125) executing programmed instructions (e.g., the virtual object interaction program 133 or the AR graphics engine 134) stored in non-transitory computer readable storage media (e.g., the memory 126) operatively connected to the controller or processor to manipulate data or to operate one or more components in the virtual object interaction system 100 to perform the task or function. Additionally, the steps of the methods may be performed in any feasible chronological order, regardless of the order shown in the figures or the order in which the steps are described.

Additionally, various AR graphical user interfaces are described for operating the AR system 120 in the Search Mode, Browse Mode, Scene Mode, and Interaction Mode. In many cases, the AR graphical user interfaces include graphical elements that are superimposed onto the user's view of the outside world or, in the case of a non-transparent display screen 128, superimposed on real-time images/video captured by the camera 129. In order to provide these AR graphical user interfaces, the processor 125 executes instructions of the AR graphics engine 134 to render these graphical elements and operates the display 128 to superimpose the graphical elements onto the user's view of the outside world or onto the real-time images/video of the outside world. In many cases, the graphical elements are rendered at a position that depends upon position or orientation information received from any suitable combination of the sensors 130 and the camera 129, so as to simulate the presence of the graphical elements in the real-world environment. However, it will be appreciated by those of ordinary skill in the art that, in many cases, an equivalent non-AR graphical user interface can also be used to operate the virtual object interaction program 133, such as a user interface provided on a further computing device such as a laptop computer, a tablet computer, a desktop computer, or a smartphone. Particularly, it should be appreciated that any AR graphical user interfaces described herein may equivalently be provided at least in the form of VR graphical user interfaces.

Moreover, various user interactions with the AR graphical user interfaces and with interactive graphical elements thereof are described. In order to provide these user interactions, the processor 125 may render interactive graphical elements in the AR graphical user interface, receive user inputs from the user, for example via gestures performed in view of the camera 129 or other sensor, and execute instructions of the virtual object interaction program 133 to perform some operation in response to the user inputs.

Finally, various forms of motion tracking are described in which spatial positions and motions of the user or of other objects in the environment are tracked. In order to provide this tracking of spatial positions and motion, the processor 125 executes instructions of the virtual object interaction program 133 to receive and process sensor data from any suitable combination of the sensors 130 and the camera 129, and may optionally utilize visual and/or visual-inertial odometry methods such as simultaneous localization and mapping (SLAM) techniques.

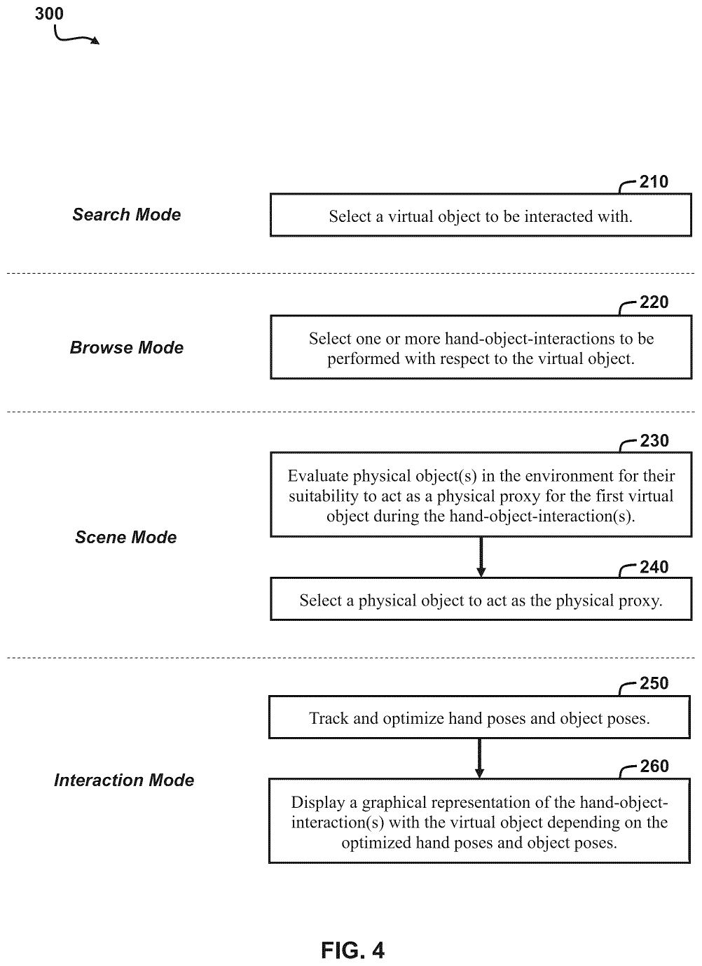

FIG. 4 shows a logical flow diagram for a method 200 for enabling hand-object interaction with a virtual object in augmented reality or virtual reality. The method 200 advantageously suggests particular physical objects in the environment to be used as physical proxies for virtual objects to be interacted with. The method 200 maintains physical and mental consistency in the user experience by recommending physical proxies in a manner that takes into consideration the interaction constraints. Finally, the method 200 advantageously incorporates a mapping process that takes into consideration the object, the hand gesture, and the contact points on both the physical and virtual object, thereby providing consistent visualization of the virtual hand-object interactions to the users.

In the Search Mode and the Browse Mode, the method 200 begins with selecting a virtual object to be interacted with (block 210). Particularly, the processor 125 receives a selection from a user of a virtual object with which at least one hand-object interaction is defined. The selected virtual object is selected from a plurality of virtual objects available for interaction in the virtual object interaction system 100, which are stored in a hand-object interaction database. The hand-object interaction database is stored in the memory 126 of the processing system 121 or by a remote computing device with which the processing system 121 is in communication.

The hand-object interaction database is created following the taxonomy of hand-object interactions discussed above. The hand-object interaction database includes a plurality of virtual objects that can be interacted with using the virtual object interaction system 100. Each virtual object has a three-dimensional model that defines a geometry and visual appearance of the virtual object, and an object classification that identifies what kind of object is represented by the three-dimensional model. The database defines one or more hand-object interactions for each virtual object.

Each hand-object interaction is also defined by a hand gesture required to perform the interaction and a contact heatmap that indicates typical points of contact between the hand and the object during the particular hand-object interaction with the particular virtual object. Additionally, each hand-object interaction is described by an affordance. In particular, it should be appreciated that the ‘affordance’ of a hand-object interaction refers to a name or description of the hand-object interaction (e.g., “grasp,” “pour,” etc.), whereas ‘hand-object interaction’ refers to all of the information that defines the interaction including the affordance, the hand gesture, and contact heatmap involved in carrying out the interaction. In some embodiments, each hand-object interaction is also classified with an interaction type that describes the nature of the interaction. The possible interaction types may, for example, include the categories of hand-object interactions discussed above: Dynamic-Continuous interactions, Static-Continuous interactions, Dynamic-Transient interactions, and Static-Transient interactions. In some embodiments, physical hand-object interactions will only be mapped to virtual hand-object interactions of the same interaction type.

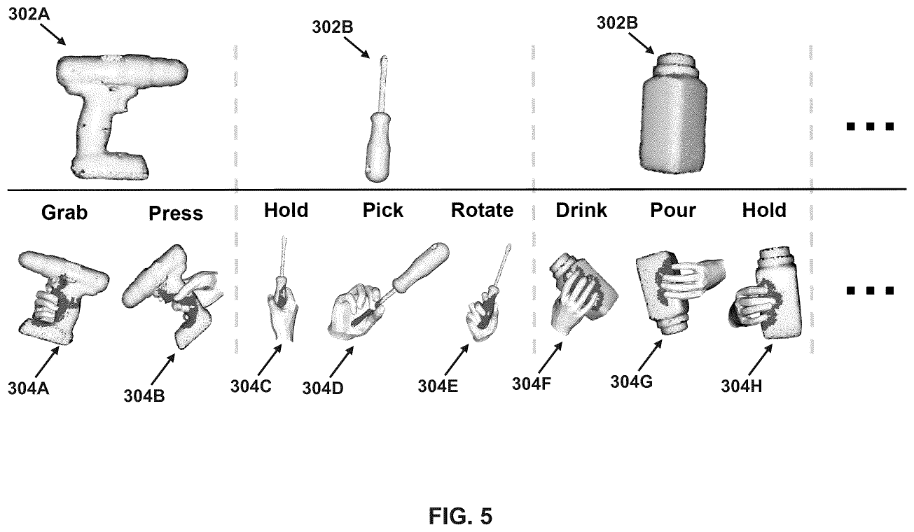

FIG. 5 shows some example hand-object interactions for different types of objects in the hand-object interaction database. In the top row, three-dimensional (3D) models for different virtual objects 302A-C are depicted, including a virtual drill 302A, a virtual screwdriver 302B, and a virtual bottle 302C. For each virtual object, one or more hand-object interactions 304A-H are defined. Particularly, with respect to the virtual drill 302A, a grab interaction 304A and a press interaction 304B are defined. Similarly, with respect to the virtual screwdriver 302B, a hold interaction 304C, a pick interaction 304D, and a rotate interaction 304E are defined. Finally, with respect to the virtual bottle 302C, a drink interaction 304F, a pour interaction 304G, and a hold interaction 304H are defined.

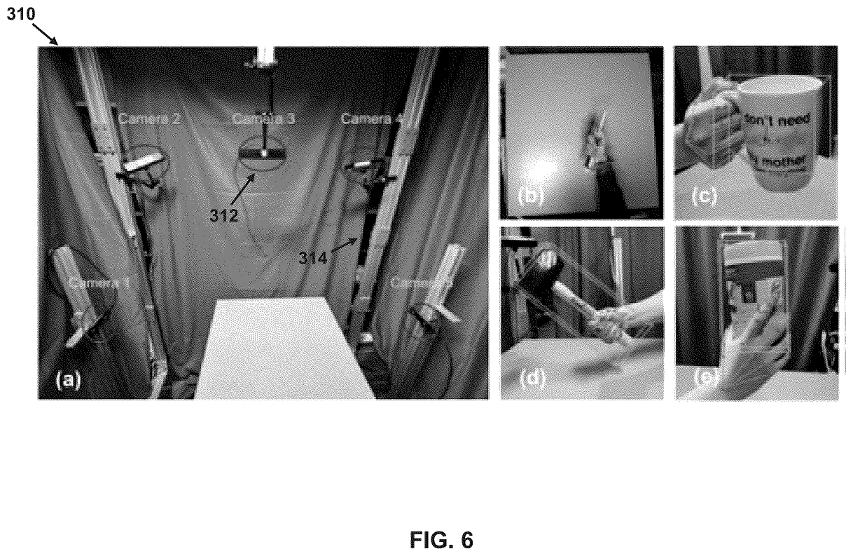

The hand-object interaction database is constructed from hand-object interactions that commonly occur in daily life. In some embodiments, the sources for collecting the interactions may include preexisting computer vision datasets such as ContactPose, GRAB, OakInk, and H20. However, in some embodiments, additional virtual objects and hand-object interactions can be added manually to the hand-object interaction database. FIG. 6 shows an exemplary hardware setup 310 for collecting data for the hand-object interaction database. As shown in illustration (a), a plurality of cameras 312 (e.g., 5 cameras) are mounted to a frame 314 to capture RGB-D images of hands interacting with various objects. As shown in illustrations (b), (c), (d), and (e), the cameras 312 are used to capture multiple views of an object during hand-object interactions, to provide a 3D model of the virtual object, and to capture obtain the hand poses, object poses, contact points, and bounding boxes for various hand-object interactions with the object. Utilizing this setup and data collection approach, interactions can be captured with new objects or objects that were not previously included in the hand-object interaction database and thus further expand the hand-object interaction database and generalize the use cases.

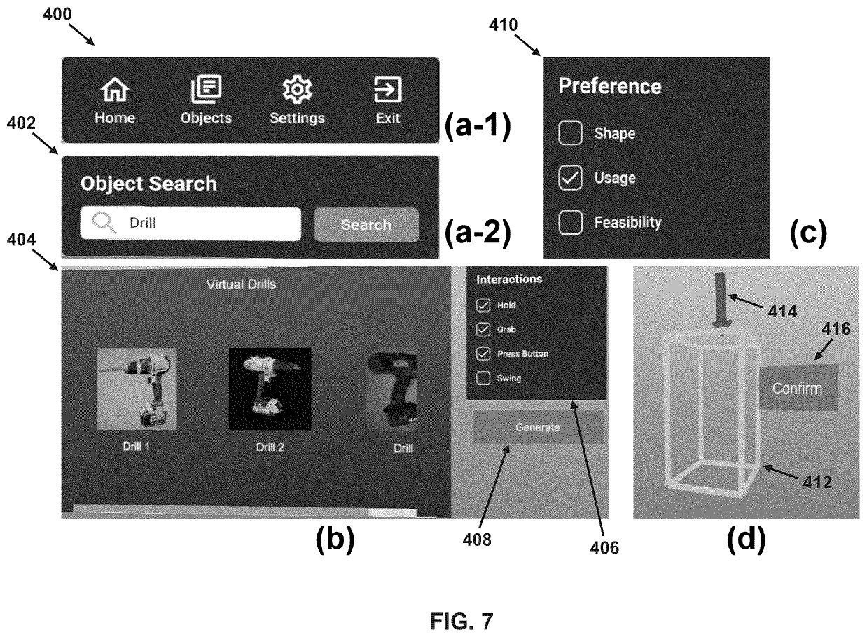

FIG. 7 shows exemplary user interface elements that are provided within the AR graphical user interface of the virtual object interaction system 100. As shown in illustration (a-1), the virtual object interaction system 100 provides an AR graphical user interface having an AR main menu 400. The AR main menu 400 is linked to the upper left of the user's field of view to facilitate mode switching. The user can select to options in the AR main menu 400 to search for virtual objects, adjust some settings, return from mapping, or exit AR from map ping. Users initiate virtual hand-object interaction by entering the Search mode to search for the virtual object they intend to interact with. In the Search Mode, as shown in illustration (a-2), the AR graphical user interface includes a virtual object search box 402. Using the virtual object search box 402, users simply type the name (e.g., “drill”) of the virtual objects they would like to search.

After entering the object's name into the virtual object search box 402, the user can switch to Browse Mode to view the available virtual objects corresponding to the searched name. In the Browse Mode, as shown in illustration (b), the AR graphical user interface provides search results in a virtual object menu 404 via which the user can select a virtual object that he or she would like to interact with.

Returning to FIG. 4, in the Browse Mode, the method 200 continues with selecting one or more hand-object interactions to be performed with respect to the virtual object (block 220). Particularly, the processor 125 receives a selection from the user of one or more hand-object interactions that the user would like to perform with respect to the selected virtual object. The selected hand-object interaction(s) are selected from the one or more hand-object interactions that are defined in the hand-object interaction database and which are associated with the selected virtual object in the hand-object interaction database.

With reference again to FIG. 7, in the Browse Mode, as shown in illustration (b), once the user selects a virtual object, the AR graphical user interface provides an interaction menu 406, e.g., to the right of the virtual object menu 404, via which the user can select or unselect hand-object interactions that he or she would like to perform with respect to the selected virtual object. In the illustrated example, the user has selected the hold interaction, the grab interaction, and the press button interaction, but has unselected the swing interaction. Thus, based on the selection, physical proxies will be recommended without consideration of performing the swing interaction. Once the user has selected the desired interactions, they can confirm by clicking a generate button 408 to enter the Scene Mode.

Returning to FIG. 4, in the Scene Mode, the method 200 continues with evaluating physical object(s) in the environment for their suitability to act as a physical proxy for the first virtual object during the hand-object interaction(s) (block 230). Particularly, the processor 125 operates the camera 129 and/or the sensors 130 to detect a plurality of physical objects in the environment of the user. The processor 125 evaluates each physical object in the environment for its suitability to act as a physical proxy for the selected virtual object during the selected hand-object interactions. More particularly, for each respective physical object detected in the environment, the processor 125 evaluates one or more suitability metrics that indicate the suitability of the respective physical object to act as the physical proxy for the selected virtual object during the selected hand-object interactions. Based on the one or more suitability metrics, the processor 125 identifies one or more of the physical objects as recommendations to be selected to act as the physical proxy.

The processor 125 operates the camera 129 and/or the sensors 130 to scan the environment of the user and to detect the plurality of physical objects in the environment, for example, as the user moves the AR-HMD 123 through the environment. In at least some embodiments, the processor 125 detects the plurality of physical objects during the scanning using an RGB-based object detection method. Next, the processor 125 obtains bounding boxes around each respective detected object and extracts a respective object point cloud for the detected object by projecting the bounding box to 3D and filtering the background points based on the distance.

Next, the processor 125 registers the detected physical objects by matching each respective physical object with a matching virtual object in the hand-object interaction database that best corresponds to the respective physical object. The processor 125 performs the matching by comparing a geometry of the respective physical object with a geometry of each virtual object in the hand-object interaction database. More particularly, the processor 125 uses the extracted object point cloud for each respective detected object as an input for instance-level retrieval of the respective matching virtual objects from the hand-object interaction database. In at least one embodiment, the processor 125 uses a deep learning-based 3D retrieval algorithm, such as PointNet, to perform the matching.

In some embodiments, the processor 125 narrows the search range down to one category by object classification to reduce the retrieval time. Thus, the matching process takes into consideration both the geometry and the object classification of the respective physical object. Particularly, the processor 125 determines an object classification of the respective physical object based on the extracted object point cloud and/or based on images of the object, e.g., using a deep learning-based object classification method. Next, the processor 125 performs the matching in part by comparing the object classification of the respective physical object with an object classification of each virtual object in the hand-object interaction database. In particular, only objects of the same object classification in the hand-object interaction database are considered in the matching process to reduce the search and retrieval time.

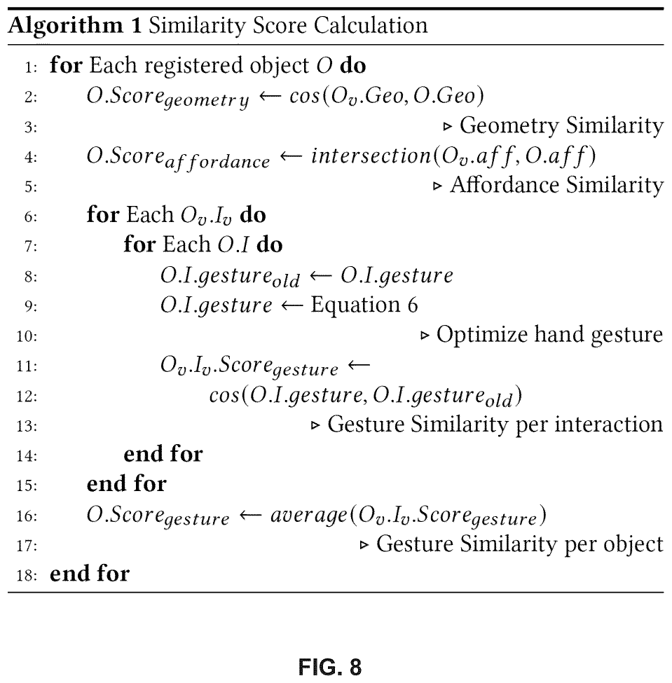

Each physical object detected and registered in the environment can be considered a candidate object for acting as the physical proxy. For each respective registered object, the processor 125 evaluates one or more suitability metrics that indicate the suitability of the respective registered object to act as the physical proxy for the selected virtual object during the selected hand-object interactions. The registered objects are evaluated based on the interaction knowledge and the target interaction given. Following the design rationale discussed previously, the virtual object interaction system 100 recommends one or more of the registered objects based on object geometries, object affordances, and hand gestures of hand-object interactions. In at least some embodiments, each of the one or more suitability metrics constitute a quantitative score for the registered objects indicating a suitability of the registered object to act as the physical proxy. FIG. 8 shows pseudocode for an Algorithm 1 used to determine the suitability of the respective registered object to act as the physical proxy. For each of the registered objects O, three distinct suitability metrics are evaluated with respect to the user-selected virtual object Oᵥ.

In one embodiment, the suitability metrics include a geometric similarity metric O.Score_{geometry} that evaluates a similarity between (i) the geometry of the virtual object Oᵥ and (ii) the geometry of a respective registered object O. Particularly, for each respective registered object O, the processor 125 determines a respective geometric similarity metric O.Score_{geometry} by comparing the geometry of the respective registered objects O with the geometry of the selected virtual object Oᵥ. The geometric similarity metric O.Score_{geometry} considers shape, curves, size, curvature, and surface normals for both the virtual object Oᵥ and the physical objects registered during scanning. Next, the processor 125 computes the geometric features of the registered objects O, as well as those of the user-selected virtual object Oᵥ. In one embodiment, the processor 125 utilizes PointNet to compute the global geometric features such as coarse shape features given the point cloud of an object. Given the two sets of geometric features of the two objects respectively, the processor 125 computes the geometric similarity metric O.Score_{geometry} in line 2 in Algorithm 1 of FIG. 8, where O.Geo and Oᵥ.Geo are the extracted geometric features of the virtual object Oᵥ and those of the physical object respectively.

In one embodiment, the suitability metrics include an affordance similarity metric O.Score_{affordance}, which may also be referred to as an interaction similarity metric, that evaluates a similarity between (i) the hand-object interactions (affordances) of the virtual object Oᵥ and (ii) the hand-object interactions (affordances) of a respective registered objects O for acting as the physical proxy. Particularly, for each respective registered objects O for acting as the physical proxy, the processor 125 determines a respective affordance similarity metric by comparing the hand-object interactions of the respective registered object O with the hand-object interactions of the selected virtual object Oᵥ. Particularly, when the user selects the interactions that he or she would like to perform with respect to the selected virtual object Oᵥ, the processor 125 generates a list of intended affordances. For each registered object O, the processor 125 obtains a corresponding list of affordances from the hand-object interaction database (i.e., a list of names or text descriptions describing hand-object interactions associated with the matching object in the database). The processor 125 then computes the affordance similarity metric between the user-selected virtual object Oᵥ and each registered object O as the intersection of the two lists as shown in line 3 in Algorithm 1 of FIG. 8, where Oᵥ.aff and O.aff are the lists of interactions of the virtual object Oᵥ and that of the registered physical object, respectively. It should be appreciated that the affordances in each list may utilize a standardized taxonomy for hand-object affordances/interactions. In this way, the intersection of the lists indicates a similarity of the lists. However, a standardized taxonomy need not be used. Instead, in some embodiments, the processor 125 utilizes a language model to evaluate the similarity between the two lists, even when the lists include affordances/interactions that do not utilize a standardized taxonomy.

In one embodiment, the suitability metrics include a gesture similarity metric O.Score_{gesture} that evaluates a similarity between (i) the hand gesture(s) used in the hand-object interactions of the virtual object Oᵥ and (ii) the hand gesture(s) used in the hand-object interactions of a respective registered objects O for acting as the physical proxy. Particularly, for each respective registered objects O for acting as the physical proxy, the processor 125 determines a respective gesture similarity metric O.Score_{gesture} by comparing the hand gesture(s) associated with each hand-object interaction of the respective registered object O with the hand gesture(s) associated with each hand-object interaction of the selected virtual object Oᵥ.

For each user-selected hand-object interaction Oᵥ.Iᵥ with the virtual object Oᵥ, the processor 125 first retrieves the hand gesture and the contact heatmap of this hand-object interaction. Next, as shown from line 6 to line 10 in Algorithm 1 in FIG. 8, for each respective interaction Oᵥ.Iᵥ of the selected virtual object Oᵥ, the processor 125 pairs the respective virtual interaction Oᵥ.Iᵥ with each possible interaction O.I of each registered object O. The processor 125 transfers the contact heatmap of the respective virtual interaction Oᵥ.Iᵥ to each registered object O to obtain the corresponding contact heatmap of the interaction on each registered object O. This yields a mapped hand gesture O.I.gesture for each registered object O. Next, the processor 125 optimizes the mapped hand gesture O.I.gesture using a process summarized by Equation 6, which is described in greater detail below. This optimization adapts the mapped hand gesture O.I.gesture to the target interaction with the respective registered object O.

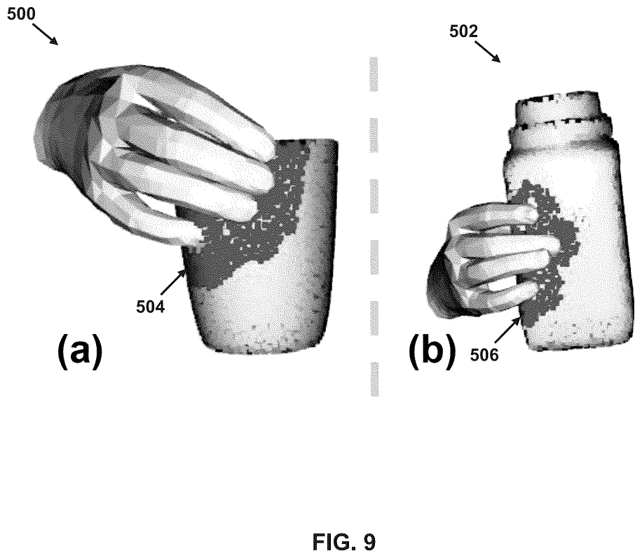

FIG. 9 shows a visualization of transferring contact heatmaps from one object to another. Particularly, illustration (a) shows the interaction 500 of a hand holding a cup, and illustration (b) shows the interaction 502 of a hand holding a bottle. Different objects in hand-object interaction yield different contact points and different gestures. As can be seen, the contact points 504 of the hand holding a cup are different than the contact points 506 of the hand holding a bottle.

Next, in each case, the processor 125 determines a similarity score Oᵥ.Iᵥ.Score_{gesture} between the mapped hand gesture O.I.gesture and the original hand gesture O.I.gesture_{old} of the interaction O.I of the registered object O. In particular, as shown in lines 11 and 12 of Algorithm 1 of FIG. 8, the processor 125 computes the similarity score as a cosine similarity between the mapped hand gesture O.I.gesture and the original hand gesture O.I.gesture_{old}. Finally, the processor 125 computes the gesture similarity metric O.Score_{gesture} as the average similarity score Oᵥ.Iᵥ.Score_{gesture} across all interactions, as shown in line 14 of Algorithm 1 of FIG. 8.

Based on the one or more suitability metrics, the processor 125 identifies one or more of the physical objects as recommendations to be selected to act as the physical proxy. To this end, the processor 125 ranks the registered objects based on each of the suitability metrics in descending order. Particularly, the processor 125 ranks the registered objects based on the geometric similarity metric O.Score_{geometry}, ranks the registered objects based on the affordance similarity metric O.Score_{affordance}, and ranks the registered objects based on the gesture similarity metric O.Score_{gesture}. Based on one or more of these rankings, the processor 125 identifies a predetermined number of the registered objects (e.g., the three highest ranking objects) as recommendations for acting as a physical proxy for the selected virtual object. In some embodiments, the processor 125 further identifies a single best recommended object from the predetermined number of recommended objects.

In at least one embodiment, the processor 125 receives a selection of a user preference for how the registered objects should be ranked and recommended. In response to receiving a first selection (e.g., “Shape”), the processor 125 ranks and recommends the registered objects base solely or primarily on the geometric similarity metric O.Score_{geometry}. In response to receiving a second selection (e.g., “Usage”), the processor 125 ranks and recommends the registered objects base solely or primarily on the affordance similarity metric O.Score_{affordance}. In response to receiving a third selection (e.g., “Feasibility”), the processor 125 ranks and recommends the registered objects base solely or primarily on the gesture similarity metric O.Score_{gesture}.

With reference again to FIG. 7, after selecting the interactions and the virtual object, in the Scene Mode, the user can now scan the environment to register the surrounding objects with the virtual object interaction system 100. During this step, a preference menu 410 will appear on the top left of the AR graphical user interface, allowing them to personalize the recommendations based on their object “Shape,” “Usage,” and “Feasibility” choices. In any case, in the Scene Mode, all of the recommended physical proxy objects are highlighted in the AR graphical user interface with bounding boxes 412, and a highest scoring (or “best”) choice is indicated with an arrow 414.

Returning to FIG. 4, in the Scene Mode, the method 200 continues with selecting a physical object to act as the physical proxy (block 240). Particularly, the processor 125 receives a selection from the user of one of the detected physical objects in the environment that the user would like to use as the physical proxy for the selected virtual object during the selected hand-object interactions. The selected physical proxy object is selected from any of the physical objects detected in the environment, and need not necessarily be the physical object that was recommended by the virtual object interaction system 100. The processor 125 determines the physical object to be used as the physical proxy in response to the selection of the selected physical proxy object by the user. With reference again to FIG. 7, the user can confirm the selected physical proxy object by interacting with a confirm button 416 arranged near the bounding box 412.

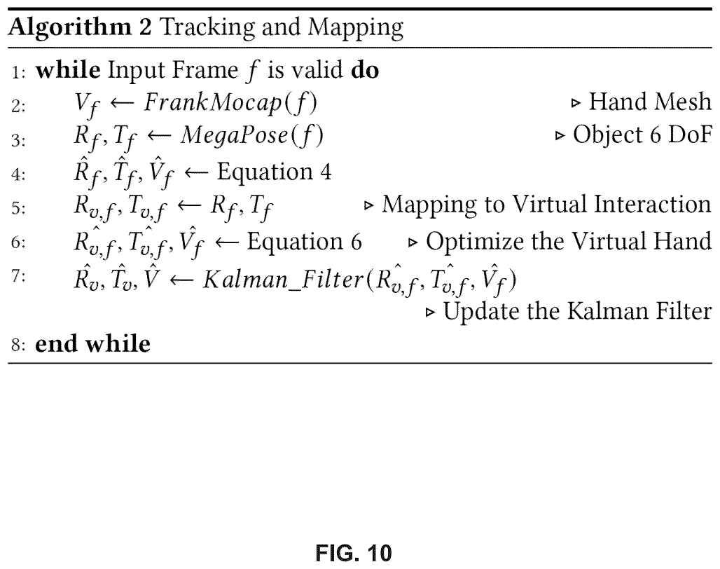

Returning to FIG. 4, in the Interaction Mode, the method 200 continues with tracking and optimizing hand poses and object poses (block 250). Particularly, the processor 125 operates the camera 129 and/or the sensors 130 to track hand poses of a hand of the user and object poses of the selected physical proxy object that is acting as the physical proxy for the virtual object. In at least some embodiments, the processor 125 further tracks the hand-object contact points between the hand of the user and the selected physical proxy object. Subsequently, the processor 125 optimizes the tracked hand poses and the tracked object poses to minimize (i) a distance between a virtual hand mesh and a virtual object mesh that represents the selected physical proxy object and (ii) a collision between the virtual hand mesh and the virtual object mesh that represents the selected physical proxy object. FIG. 10 shows pseudocode for an Algorithm 2 for tracking physical hand and object poses and mapping them to a virtual hand-object interaction.

The processor 125 tracks the hand poses of the hand of the user in the form of a time series of joint positions (i.e., vertices) that define the hand poses (i.e., gestures) performed by the user within the environment over time. Each sample in the time series corresponds to a respective image frame from the video captured by the camera 129. In one embodiment, for each sensor input frame f, the processor 125 tracks the hand poses of the hand using a deep learning-based hand-tracking algorithm, such as FrankMocap, to arrive at hand poses V_{f} in line 2 of Algorithm 2 of FIG. 10. The biggest advantage provided by a deep learning-based hand-tracking algorithm is detecting hands in complex scenarios such as cluttered backgrounds, different lighting conditions, motion blur, and occlusion.

The processor 125 tracks the object poses of the selected physical proxy object as a time series of 6-DoF object positions/translations and orientations/rotations of the selected physical proxy object within the environment over time. Each sample in the time series corresponds to a respective image frame from the video captured by the camera 129. In one embodiment, for each sensor input frame f, the processor 125 tracks the object poses of the selected physical proxy object using a deep learning-based object tracking algorithm, such as MegaPose, to arrive at 6-DoF object poses R_{f}, T_{f} in line 3 of Algorithm 2 of FIG. 10. MegaPose utilizes geometric and visual features from the input data to improve the accuracy of the 6-DoF object poses. In one embodiment, after obtaining the initial results from MegaPose, the processor 125 further refines the object poses using an iterative closest point (ICP) algorithm. Performing this step frame by frame ensures that the object pose is accurately tracked over time, and can be especially important when analyzing complex interactions between the object and other elements in the scene.

As will be discussed in greater detail below, the tracked hand poses and the tracked object poses will be used to generate graphical representations of hand-object interactions with the selected virtual object. The graphical representation incorporates a 3D model/mesh of a virtual hand and a 3D model/mesh of the selected virtual object, which are rendered to mirror the tracked hand poses and the tracked object poses, respectively. However, separate tracking of both hands and objects often results in implausible 3D reconstructions. Particularly, in some cases, the virtual object and the virtual hand may appear too far from one another. Conversely, in some cases, the virtual object and the virtual hand may intersect or interpenetrate with one another. These visual issues tend to break the immersion of the user and provide a less realistic experience.

To avoid these problems, the processor 125 jointly optimizes the tracked hand poses and the tracked object poses by minimizing an Interaction Loss and a Collision Loss. For this purpose, for each frame of the tracked hand pose data, the processor 125 defines a virtual hand mesh of the hand of the user based on the tracked hand pose and using a 3D virtual hand model. Likewise, for each corresponding frame of the tracked object pose data, the processor 125 defines a virtual object mesh of the selected physical proxy object based on the tracked object pose and using the 3D model for the matching virtual object determined during registration of the selected physical proxy object. Thus, the virtual hand mesh represents the hand of the user and the virtual object mesh represents the selected physical proxy object.

The Interaction Loss characterizes a distance between a virtual hand mesh and a virtual object mesh. Particularly, due to estimation errors, hand poses and object poses can be distant from each other in the 3D space even though contact happens in reality. In one embodiment, the processor 125 calculates the Interaction Loss as a Chamfer distance between the virtual hand mesh and the virtual object mesh when contact happens (i.e., when the user is interacting with the selected physical proxy object). For every vertex within the virtual hand mesh, the Chamfer distance function calculates the distance to the nearest point in the virtual object mesh and subsequently aggregates the distances, as shown in Equation 1:

$${L}_{Interaction} = \frac{1}{\vert {v}_{object} \vert} {\sum }_{x ∈ {V}_{object}} {min}_{y ∈ {V}_{h a n d}} ‖ x - y {‖}_{2} + \frac{1}{\vert {V}_{h a n d} \vert} {\sum }_{x ∈ {V}_{h a n d}} {min}_{y ∈ {V}_{object}} ‖ x - y {‖}_{2} , \qquad ( 1 )$$

where V_{object} are the virtual object mesh vertices and V_{hand} are the virtual hand mesh vertices.

The Collision Loss characterizes a collision between the virtual hand mesh and the virtual object mesh. Particularly, object poses can interpenetrate hand poses, causing the virtual object mesh to intersect with the virtual hand mesh. To resolve this collision issue, the processor 125 calculates the Collision Loss in a manner that penalizes virtual object mesh vertices that are inside of the virtual hand mesh. In one embodiment, the processor 125 calculates the Collision Loss using a Signed Distance Field function (SDF) that checks if the virtual object mesh vertices are inside the virtual hand mesh, as shown in Equation 2:

$$ϕ ( v ) = - min ( S D F ( {v}_{x} , {v}_{y} , {v}_{Z} ) , 0 ) . \qquad ( 2 )$$

If the cell is inside the virtual hand mesh, ϕ takes positive values proportional to the distance from the hand surface, and ϕ is 0 otherwise. The processor 125 calculates the Collision Loss according to Equation 3:

$${L}_{c o l l i s i o n} = {\sum }_{v ∈ {V}_{object}} ϕ ( v ) . \qquad ( 3 )$$

The processor 125 jointly optimizes the tracked hand poses and the tracked object poses by minimizing an Interaction Loss and a Collision Loss, according to the joint optimization function of Equation 4:

$$\hat{θ} = {arg min}_{θ ∈ {R}^{45}} ( {L}_{Interaction} + {L}_{c o l l i s i o n} ) , \qquad ( 4 )$$

where \hat{θ} is the optimized hand pose while interacting with the selected physical proxy object. With reference again to FIG. 10, the processor 125 uses Equation 4 to determine optimized hand poses \hat{V}_{f} and optimized object poses \hat{R}_{f}, \hat{T}_{f}, in line 4 of Algorithm 2.

Once the tracked hand poses and the tracked object poses are jointly optimized, the processor 125 determines the hand-object contact points between the hand of the user and the selected physical proxy object based on the optimized hand poses and the optimized object poses. The processor 125 determines the hand-object contact points between the hand of the user and the selected physical proxy object as a time series of contact points on the virtual object mesh or on the virtual hand mesh. In some embodiments, the processor 125 determines the hand-object contact points between the hand of the user and the selected physical proxy object as a time series of contact heatmaps on the surface of the virtual object mesh and/or on the surface of the virtual hand mesh. In one embodiment, the processor 125 calculates the hand-object contact points by finding the nearest vertices on the virtual object mesh within a certain threshold for each vertex in the virtual hand mesh. Next, the processor 125 computes a histogram by counting the number of neighbors for each vertex of the virtual hand mesh. Finally, the processor 125 uses the histogram to normalize and model a contact heatmap on the surface of the virtual object mesh. The same process is repeated for the virtual object mesh to generate a contact heatmap on the surface of the virtual hand mesh.

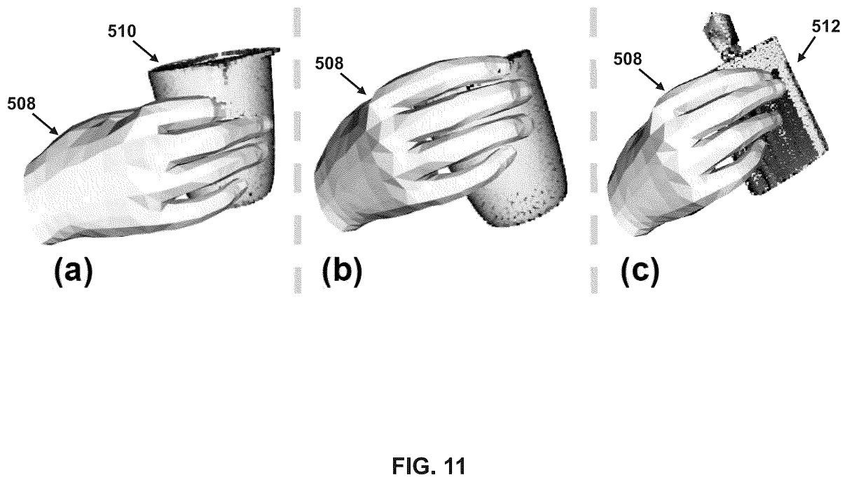

FIG. 11 shows an exemplary hand and object pose optimization process. Particularly, as shown in illustration (a), given the tracked hand pose and tracked object pose, a virtual hand mesh 508 and virtual object mesh 510 (corresponding to a cup) are defined. As can be seen, the virtual hand mesh 508 is penetrating the virtual object mesh 510, which is not realistic and may break the immersion of the user. Next, as shown in illustration (b), the tracked hand pose and tracked object pose are optimized so as to correct the hand pose and the distance between the object and the hand. As can be seen, after optimization, the virtual hand mesh 508 makes more realistic contact with the surface of the virtual object mesh 510.

In the Interaction Mode, the method 200 continues with displaying a graphical representation of the hand-object interaction(s) with the virtual object depending on the optimized hand pose and object pose (block 260). Particularly, the processor 125 renders and operates the display screen 128 to display, in an AR (or VR) graphical user interface, a graphical representation of hand-object interactions with the selected virtual object based on the tracked hand poses and the tracked object poses. The graphical representation of the hand-object interactions is intended to mirror the physical interaction between the hand of the user and the selected physical proxy object. Thus, in this way, the virtual object interaction system maps the physical hand-object interaction between the selected physical proxy object and the user's hand to the virtual hand-object interaction between the virtual hand and the selected virtual object.

With reference again to FIG. 10, the processor 125 determines virtual object poses R_{v,f}, T_{v,f} of the selected virtual object based on the optimized object poses \hat{R}_{f}, \hat{T}_{f} of the selected physical proxy object based using a mapping process, in line 5 of Algorithm 2 in FIG. 10. In one embodiment, to map the object poses of the selected physical proxy object to the selected virtual object, the user first initializes the virtual object pose of the selected virtual object by manipulating and aligning the selected virtual object in the AR graphical user interface to overlay upon the selected physical proxy object. Next, the processor 125 interpolates the shape from the selected physical proxy object to the selected virtual object and stores the interpolation information. During interaction, the processor 125 tracks the frame-wise translation and rotation of the selected physical proxy object, as discussed above, and transforms the object poses after optimization to determine the virtual object poses of the selected virtual object. This allows the virtual object to match the position/translation and orientation/rotation of the selected physical proxy object, so that the contact points can be accurately transferred. After determining the virtual object poses of the selected virtual object, the processor 125 leverages the interpolation to transfer the hand-object contact points from the selected physical proxy object to the selected virtual object for every frame.

After determining the hand-object contact points on the selected virtual object, the processor 125 jointly optimizes the hand poses and the virtual object poses to minimize (i) a distance between the virtual hand mesh and a virtual object mesh that represents the selected virtual object, (ii) a collision between the virtual hand mesh and the virtual object mesh, and (iii) a distance between the hand mesh and the hand-object contact points on the selected virtual object. In other words, the processor 125 jointly optimizes the hand poses and the virtual object poses of the selected virtual object by minimizing the Interaction Loss, the Collision Loss, and a Contact Loss.

The Contact Loss characterizes a distance between the virtual hand mesh and the mapped hand-object contact points on the selected virtual object. The processor 125 determines the Contact Loss by computing the Chamfer distance between the virtual hand mesh and the mapped hand-object contact points on the selected virtual object, according to Equation 5:

$${L}_{contact} = \frac{1}{\vert C \vert} {\sum }_{x ∈ C} {min}_{y ∈ {V}_{h a n d}} ‖ x - y {‖}_{2} + \frac{1}{\vert {V}_{h a n d} \vert} {\sum }_{x ∈ {V}_{h a n d}} {min}_{y ∈ C} ‖ x - y {‖}_{2} , \qquad ( 5 )$$

where C are the mapped hand-object contact points on the selected virtual object.

Thus, the processor 125 jointly optimizes the hand poses and the virtual object poses by minimizing the Interaction Loss, the Collision Loss, and the Contact Loss according to the joint optimization function of Equation 6:

$$\hat{θ} = {arg min}_{θ ∈ {R}^{45}} ( {L}_{Interaction} + {L}_{c o l l i s i o n} + {L}_{contact} ) , \qquad ( 6 )$$

where \hat{θ} is the further optimized hand pose while interacting with the selected virtual object. With reference again to FIG. 10, the processor 125 uses Equation 6 to determine optimized hand poses \hat{V}_{v,f} and optimized object poses \hat{R}_{v,f}, \hat{T}_{v,f}, in line 6 of Algorithm 2. Lastly, in line 7 of the Algorithm 2, in some embodiments, a Kalman Filter is updated to arrive at the final optimized values \hat{R}ᵥ, \hat{T}ᵥ, \hat{V}.

With reference again to FIG. 11, as shown in illustration (c), the interaction between the virtual hand mesh 508 and the virtual object mesh 510 (corresponding to a cup) is mapped onto an interaction between the virtual hand mesh 508 and a different virtual object mesh 512 (corresponding to a flask). As can be seen, this different interaction is similarly optimized in order to get consistently represented virtual interactions.

Finally, once the hand poses and virtual object poses are optimized, the processor 125 renders and operates the display screen 128 to display, in an AR (or VR) graphical user interface, a graphical representation of hand-object interactions between the selected virtual object based on the optimized hand poses and the optimized virtual object poses. The processor 125 renders, in the AR (or VR) graphical user interface, the object mesh of the selected virtual object with a position and orientation depending on the optimized virtual object poses. Likewise, the processor 125 renders, in the AR (or VR) graphical user interface, the hand mesh with a gesture depending on the optimized hand poses. In general, the object mesh of the selected virtual object is overlaid upon the selected physical proxy object. Likewise, the hand mesh is, roughly speaking, overlaid upon the hand of the user. However, it should be appreciated that due to the mapping and optimization, a natural and realistic interaction between the virtual object and the virtual hand is prioritized over precise overlay of the virtual hand on the user's hand.

### Exemplary Use Cases

Given a target interaction with a virtual object, the virtual object interaction system 100 assists the users in locating the best object in their vicinity to interact with, maps the real-world hand-object interaction to the virtual interaction, and enables control over the virtual object within AR/VR applications. Four different use cases of the virtual object interaction system 100 are demonstrated in the following descriptions and figures.

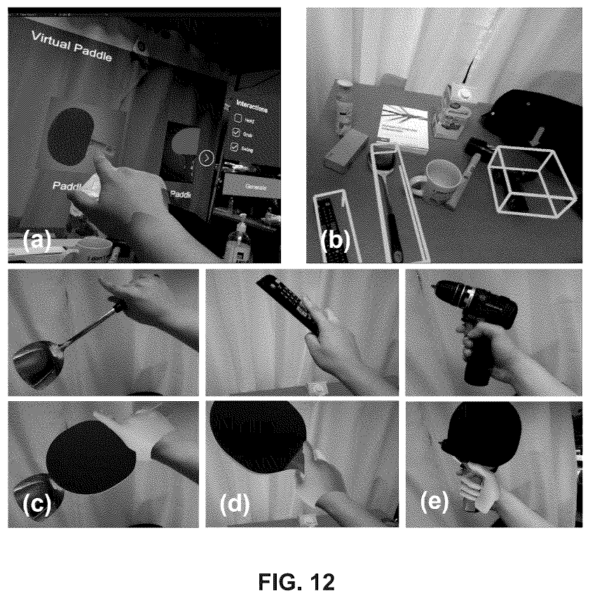

FIG. 12 shows an exemplary use case involving practicing table tennis. Many objects can be interacted with in similar ways. The virtual object interaction system 100 takes advantage of the fact that the similarity between virtual interaction and physical interaction yields mental and physical consistency and immersiveness in the user experience in AR applications. By utilizing hand-object interaction as the criterion, the virtual object interaction system 100 expands the range of possible proxies for tangible AR by diminishing the constraint of the physical object geometry without sacrificing consistency in the user experience.

As shown in FIG. 12 (a), a user would like to practice table tennis with a virtual paddle by grabbing the handle and swinging the paddle. Given the target interactions grabbing and swinging, the virtual object interaction system 100 locates a remote, a screwdriver, and a spatula after scanning the users' vicinity, as shown FIG. 12 (b). They can be grabbed and swung similarly to a paddle, despite the different geometry. virtual object interaction system 100 recommends the interaction with those objects based on the similarity scores as shown in FIG. 12 (b). Upon user selection, the virtual object interaction system 100 tracks the hand pose and the 6-DoF object pose in the physical world, as shown in FIG. 12 (c,d,e), and maps the hand-object interaction to the virtual world.

The possibility of tangible AR is enlarged by the virtual object interaction system 100 not only in the physical world but also in the virtual world. As shown in FIG. 12, virtual interactions with diverse objects (swinging a baseball bat, pressing the shutter of a camera, and screwing the cap on a bottle) can all be respectively mapped into similar interactions with one object (swinging a dispenser, pressing the pump head of a dispenser, and screwing the cap on a dispenser).

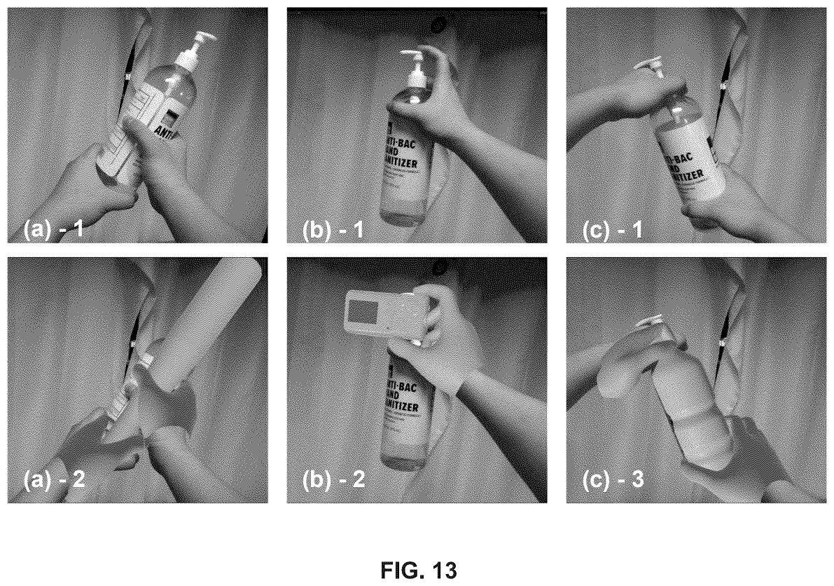

FIG. 13 shows a demonstration of how interaction mapping increases the possibility of tangible proxies. As shown in illustration (a)-1, a sanitizer dispenser can be grabbed. As shown in illustration (b)-1, the sanitizer dispenser can be pressed at the pump. As shown in illustration (c)-1, the sanitizer dispenser's cap can be screwed. The same interaction can be mapped into the virtual world by the virtual object interaction system 100. As shown in illustration (a)-2, a virtual baseball bat can be grabbed. As shown in illustration (b)-2, a camera can be pressed at the shutter. As shown in illustration (c)-2, a bottle cap can be screwed using similar interactions with the dispenser.

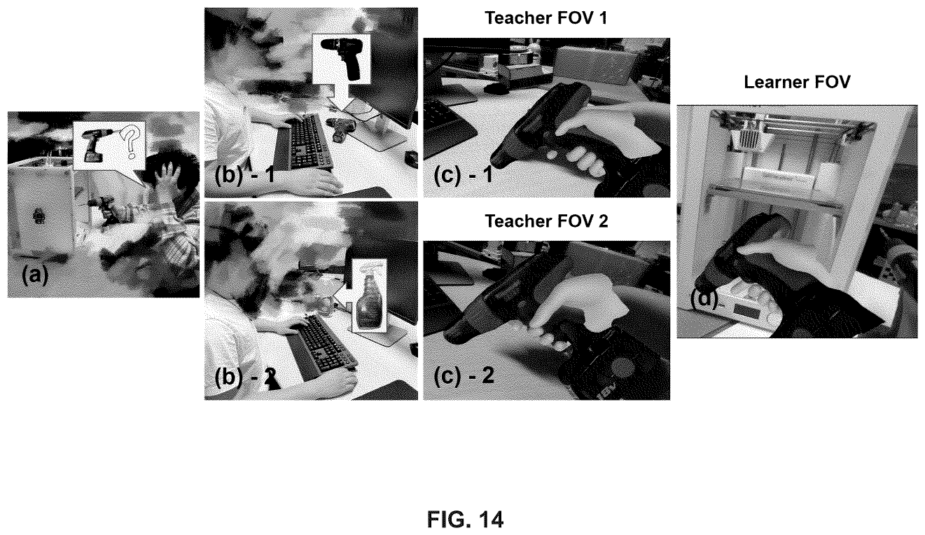

FIG. 14 shows an exemplary use case involving a one-on-one remote tutoring scenario. Recent research has shown that AR can provide a more immersive and effective approach to hands-on training and education when combined with a sense of co-presence. The virtual object interaction system 100 empowers such AR applications with more realistic hand-object interactions with haptic feedback. In FIG. 14, a teacher in the office is tutoring a learner in the factory with the use of a hand drill. However, the teacher possesses a different hand drill (A) from that (B) of the learner, as shown in illustration (b)-1. The virtual object interaction system 100 scans the vicinity in the office and suggests hand drill A to the teacher as the best-available proxy to interact with. To teach the learner how to grab and hold the hand drill as well as press the power button, the teacher demonstrates the interactions. The virtual object interaction system 100 captures the teacher's interaction with hand drill A, as shown in illustration (c), creates the virtual counterpart of this interaction with hand drill B, and then displays in real-time the rendered virtual interaction to the learner, as shown in illustration (d). Despite the differences in object geometry and hand gesture, the virtual object interaction system 100 is able to map the grabbing, holding, and pressing interactions with hand drill A to corresponding interactions with hand drill B and provides accurate instruction to the learner as well as realistic haptic feedback to the teacher.

Considering a more challenging case, where the teacher does not possess any hand drill in the office, the virtual object interaction system 100 scans the vicinity and looks for the best-available object to grab, hold, and press like a hand drill. It eventually suggests the sprinkler, as shown in illustration (b)-2. The teacher interacts with the sprinkler as a proxy. The target interactions are mapped to those with hand drill B and rendered in the learner's display as instructions, as shown in illustration (c)-2.

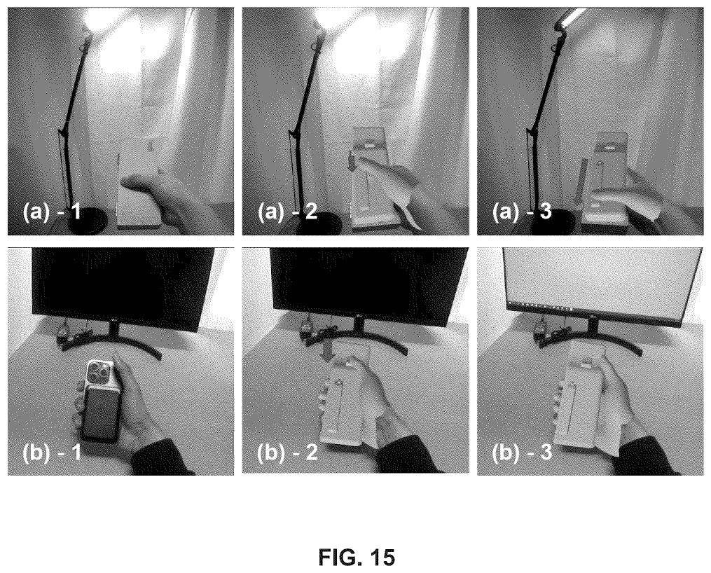

FIG. 15 shows an exemplary use case involving a tangible user interface for a smart home. Recent development in the Internet of Things (IoT) has enabled the deployment of Smart Home devices and appliances that are interconnected through the IoT technology, enabling automation, remote control, and monitoring of household tasks and systems. The virtual object interaction system 100 can also be applied to prototype Tangible User Interfaces (TUI) in AR to control Smart Homes.

Given any predefined interaction with a smart home's controller as the template, the virtual object interaction system 100 suggests all possible nearby objects that can be assigned the same functionality (buttons, sliders) as the virtual controller and can be interacted with similarly, as shown in illustrations (a) and (b). Upon user selection, the virtual object interaction system 100 tracks the interactions with the selected object and overlays the virtual functionality onto the object, as shown in illustrations (a)-2, (b)-2. The user can hold the controller towards a smart home device and press the virtual button by pressing on the designated part of the object to switch on and off the device in the room, as shown in illustration (b)-3. Meanwhile, the user can adjust the brightness of the light by sliding their fingers on the virtual slider while holding the controller towards the device. The same interactions can be mapped to different possible objects by the virtual object interaction system 100, as shown in illustration (a)-3.

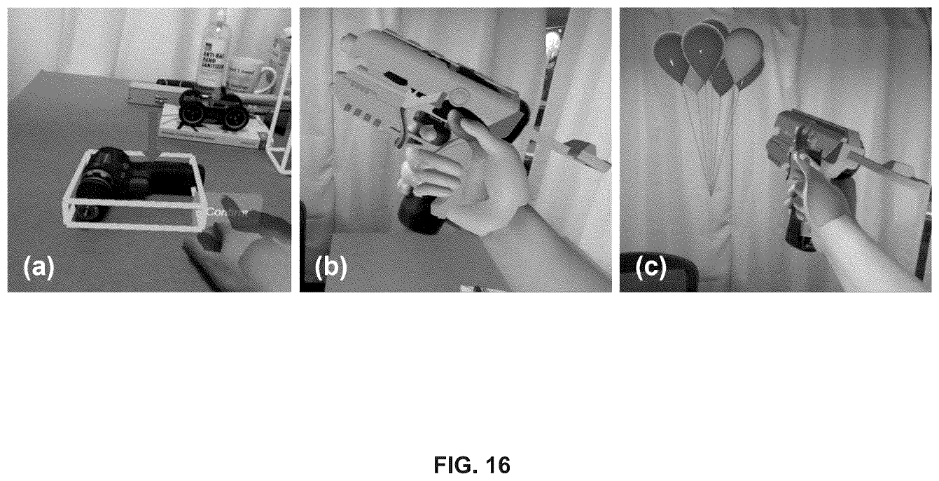

FIG. 16 shows an exemplary use case involving an AR shooting game. Particularly, the virtual object interaction system 100 can also benefit users with tangible controllers in various AR gaming scenarios. As shown in FIG. 16, the user wants to play a balloon-shooting AR game and seeks a proxy for a Nerf Gun, as shown in illustration (a). The virtual object interaction system 100 scans for objects that can be grabbed and pressed (pulling the trigger) and suggests a sprayer and a drill, as shown in illustration (a). Both of them can be interacted with as a proxy for the Nerf Gun. By blending the consistent hand-object interaction into the physical world, the virtual object interaction system 100 enables the users to immersively interact with the virtual objects with proximate haptic feedback. When the trigger on the drill is pulled by the user, the same virtual interaction will be mapped to, rendered, and blended into the display of the user, as shown in illustration (c). The user can aim with the virtual Nerf Gun by moving the drill, and shoot the virtual balloons as shown in illustration (c) by physically pulling the trigger.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for enabling hand-object interactions with a virtual object in augmented reality or virtual reality, the method comprising:
receiving, with a processor, a selection from a user of a first virtual object with which at least one first interaction is defined;
determining, with the processor, a first physical object in the environment to act as a physical proxy for the first virtual object during the at least one first interaction;
tracking, with the processor, hand poses of a hand of the user and object poses of the first physical object within the environment over time; and
displaying, in an augmented reality or virtual reality graphical user interface on a display screen, a graphical representation of the at least one first interaction with the first virtual object based on the hand poses and the object poses, the graphical representation of the at least one first interaction mirroring a physical interaction between the hand of the user and the first physical object.

2. The method according to claim 1 further comprising:
receiving, with the processor, a selection of the at least one first interaction from a plurality of first interactions associated with the first virtual object.

3. The method according to claim 1, the determining the first physical object further comprising:
detecting, with at least one sensor, a plurality of physical objects in the environment;
evaluating at least one respective suitability metric for each respective physical object in the plurality of physical objects indicating a suitability of the respective physical object to act as the physical proxy for the first virtual object during the at least one first interaction; and
determining the first physical object depending on the at least one respective suitability metric for each respective physical object in the plurality of physical objects.

4. The method according to claim 3, the evaluating the at least one respective suitability metric for each respective physical object further comprising:
determining a respective geometric similarity metric by comparing a geometry of the respective physical object with a geometry of the first virtual object.

5. The method according to claim 3, the determining the first physical object further comprising:
storing, in a memory, a plurality of virtual objects; and
matching each respective physical object in the plurality of physical objects to a respective second virtual object that corresponds to the respective physical object from the plurality of virtual objects.

6. The method according to claim 5, the matching further comprising:
matching each respective physical object in the plurality of physical objects to the respective second virtual object (i) by comparing a geometry of the respective physical object with a geometry of the respective second virtual object and (ii) by comparing an object classification of the respective physical object with an object classification of the respective second virtual object.

7. The method according to claim 5, wherein the respective second virtual object is associated with at least one second interaction, the evaluating the at least one respective suitability metric for each respective physical object further comprising:
determining a respective interaction similarity metric by comparing the at least one second interaction with the at least one first interaction.

8. The method according to claim 5, wherein each of the at least one first interaction is associated with at least one first hand gesture and each of the at least one second interaction is associated with at least one second hand gesture, the evaluating the at least one respective suitability metric for each respective physical object further comprising:
determining a respective gesture similarity metric by comparing the at least one second hand gesture associated with each of the at least one second interaction with the at least one first hand gesture associated with each of the at least one first interaction.

9. The method according to claim 3, the determining the first physical object further comprising:
identifying, based on the at least one respective suitability metric for each respective physical object, at least one recommended physical object in the environment to act as the physical proxy for the first virtual object during the at least one first interaction; and
determining the first physical object in response to a selection by the user of the first physical object from the at least one recommended physical object.

10. The method according to claim 1, the displaying the graphical representation of the at least one first interaction with the first virtual object further comprising:
defining a hand mesh of the hand of the user based on the hand pose;
defining a first object mesh of the first physical object based on the object pose; and
jointly optimizing the hand poses and the object poses to minimize (i) a distance between the hand mesh and the first object mesh and (ii) a collision between the hand mesh and the first object mesh.

11. The method according to claim 10, the jointly optimizing the hand poses and the object poses further comprising:
calculating a Chamfer distance between the hand mesh and the first object mesh.

12. The method according to claim 10, the jointly optimizing the hand poses and the object poses further comprising:
checking whether vertices of the first object mesh are within the hand mesh or whether vertices of the hand mesh are within the first object mesh, by evaluating a Signed Distance Field function.

13. The method according to claim 10, the displaying the graphical representation of the at least one first interaction with the first virtual object further comprising:
determine virtual object poses of the first virtual object based on the object poses of the first physical object.

14. The method according to claim 13, the displaying the graphical representation of the at least one first interaction with the first virtual object further comprising:
defining a second object mesh of the first virtual object based on the virtual object poses of the first virtual object;
determining first points of contact between the hand of the user and the first physical object based on the hand poses of the hand of the user and the object poses of the first physical object; and
determining second points of contact between the hand mesh and the second object mesh by transferring the first points of contact to second object mesh.

15. The method according to claim 14, the displaying the graphical representation of the at least one first interaction with the first virtual object further comprising:
jointly optimizing the hand poses and the virtual object poses to minimize (i) a distance between the hand mesh and the second object mesh, (ii) a collision between the hand mesh and the second object mesh, and (iii) a distance between the hand mesh and the second points of contact.

16. The method according to claim 15, the jointly optimizing the hand poses and the virtual object poses further comprising:
calculating a Chamfer distance between the hand mesh and the second points of contact.

17. The method according to claim 13 the displaying the graphical representation of the at least one first interaction with the first virtual object further comprising:
rendering, in the augmented reality or virtual reality graphical user interface, a second object mesh of the first virtual object with a position and orientation depending on the virtual object poses; and
rendering, in the augmented reality or virtual reality graphical user interface, the hand mesh with a gesture depending on the hand poses.

18. A non-transitory computer-readable storage medium that stores program instructions for enabling hand-object interactions with a virtual object in augmented reality or virtual reality, the program instructions being configured to, when executed by computing device, cause the computing device to:
receive a selection from a user of a first virtual object with which at least one first interaction is defined;
determine a first physical object in the environment to act as a physical proxy for the first virtual object during the at least one first interaction;
track hand poses of a hand of the user and object poses of the first physical object within the environment over time; and
operate a display to display, in an augmented reality or virtual reality graphical user interface, a graphical representation of the at least one first interaction with the first virtual object based on the hand poses and the object poses, the graphical representation of the at least one first interaction mirroring a physical interaction between the hand of the user and the first physical object.
